(19) United States
(12) Patent Application Publication
(10) Pub. No.: US 2021/0333655 A1
(43) Pub. Date: Oct. 28, 2021

(54) DISPLAY PANEL HAVING MULTI-DOMAIN PIXEL STRUCTURE

(71) Applicant: SHENZHEN CHINA STAR OPTOELECTRONICS SEMICONDUCTOR DISPLAY TECHNOLOGY CO., LTD., Shenzhen (CN)

(72) Inventor: Wu CAO, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/626,538

(22) PCT Filed: Nov. 4, 2019
(86) PCT No.: PCT/CN2019/115362

§ 371 Date: Dec. 25, 2019

(30) Foreign Application Priority Data
Jun. 5, 2019 (CN) 201910487942.X

(51) Int. Cl. G02F 1/1343

(52) U.S. Cl. CPC G02F 1/134345; G02F 1/1368

(57) ABSTRACT

The present disclosure provides a display panel having a multi-domain pixel structure. The display panel includes at least three subpixels, and each of the at least subpixels includes a main pixel area and a sub pixel area; the main pixel area of the subpixel and the sub pixel area of the subpixel are set according to a preset area ratio; wherein, the main pixel area and the sub pixel area of a part of the subpixels on the display panel are positionally flipped with the main pixel area and the sub pixel area of another part of the subpixels at a preset angle.

### FIELD OF INVENTION

The present disclosure relates to the technology field of displays, and particularly, relates to a display panel having a multi-domain pixel structure.

### BACKGROUND OF INVENTION

In 3T pixels, in a 3T architecture of 8-domains, pixels are divided into a main pixel area and a sub pixel area. Since the main pixel area and the sub pixel area in a same time period (a same gray scale/a certain image) have a differential voltage that is inconsistent with the upper glass board (CF substrate), the differential voltage in the main pixel area is generally larger, while a differential voltage in the sub pixel area is smaller. Upon actual lighting, it is found that, particularly in a middle-low gray scale, the pixels mainly contribute brightness by the main pixel area. Therefore, in the 3T pixels, due to a presence of voltage division ratio, in the middle-low gray scale, luminance is mainly contributed by the main pixel area. Meanwhile the sub pixel area is in a very dark state, and even a threshold voltage of liquid crystal deflection cannot be reached. Therefore, when the display panel is in a middle-low gray scale, the delicateness of a fine image is insufficient, which leads to a technical problem of display effect being affected.

Therefore, the prior art has drawbacks and is in urgent need of improvement.

### SUMMARY OF INVENTION

The present disclosure provides a display panel having a multi-domain pixel structure, which solves the problem that the display panel with the multi-domain pixel structure has insufficient delicateness of the images and affects the display effect in the middle-low gray scale.

To solve the above problems, the technical solutions provided by the present disclosure are as follows:

The present disclosure provides a display panel having a multi-domain pixel structure including an array of pixel units, each of the pixel units includes at least three subpixels, each of the at least subpixels includes a main pixel area and a sub pixel area;

the main pixel area of the subpixel and the sub pixel area of the subpixel are disposed according to a preset area ratio;

therein, the main pixel area and the sub pixel area of a part of the subpixels on the display panel are positionally flipped with the main pixel area and the sub pixel area of another part of the subpixels at a preset angle, thereby increasing a degree of disorder of arrangement positions of the main pixel area and the sub pixel area.

In the display panel of the present disclosure, a relative positional relationship between the main pixel area and the sub pixel area of different subpixels in a same pixel unit remains same.

In the display panel of the present disclosure, the main pixel area and the sub pixel area of the subpixels in two adjacent pixel units are 180° inverted in position.

In the display panel of the present disclosure, at least two of the pixel units are defined as a pixel group, and the main pixel area and the sub pixel area of the subpixels in two adjacent pixel groups are 180° inverted in position.

In the display panel of the present disclosure, in a same pixel unit, the main pixel area and the sub pixel area of two adjacent subpixels are 180° inverted in position.

In the display panel of the present disclosure, at least two of the subpixels are defined as a sub-pixel group, and the main pixel area and the sub pixel area of the subpixels in two adjacent sub-pixel groups are 180° inverted in position.

In the display panel of the present disclosure, the display panel further includes a data line and a scan line, wherein two adjacent pixel units, sub-pixels, pixel groups, or sub-pixel groups are arranged adjacently along an extending direction of the scan line and/or the data line.

In the display panel of the present disclosure, an area of the main pixel area accounts for 25% to 50% of an entire aperture ratio of the subpixel.

In the display panel of the present disclosure, the area of the main pixel area accounts for 40% to 50% of the entire aperture ratio of the subpixel.

In the display panel of the present disclosure, a pixel structure of the display panel is one of two domains, four domains, or eight domains.

To solve the above problems, the present disclosure further provides a display panel having a multi-domain pixel structure including an array of pixel units, each of the pixel units includes at least three subpixels, each of the at least subpixels includes a main pixel area, a sub pixel area, and three thin film transistors; and

the main pixel area of the subpixel and the sub pixel area of the subpixel are disposed according to a preset area ratio;

therein, the main pixel area and the sub pixel area of a part of the subpixels on the display panel are positionally flipped with the main pixel area and the sub pixel area of another part of the subpixels at a preset angle, thereby increasing a degree of disorder of arrangement positions of the main pixel area and the sub pixel area.

In the display panel of the present disclosure, a relative positional relationship between the main pixel area and the sub pixel area of different subpixels in a same pixel unit remains same.

In the display panel of the present disclosure, the main pixel area and the sub pixel area of the subpixels in two adjacent pixel units are 180° inverted in position.

In the display panel of the present disclosure, at least two of the pixel units are defined as a pixel group, and the main pixel area and the sub pixel area of the subpixels in two adjacent pixel groups are 180° inverted in position.

In the display panel of the present disclosure, in a same pixel unit, the main pixel area and the sub pixel area of two adjacent subpixels are 180° inverted in position.

In the display panel of the present disclosure, at least two of the subpixels are defined as a sub-pixel group, and the main pixel area and the sub pixel area of the subpixels in two adjacent sub-pixel groups are 180° inverted in position.

In the display panel of the present disclosure, the display panel further includes a data line and a scan line, wherein two adjacent pixel units, sub-pixels, pixel groups, or sub-pixel groups are arranged adjacently along an extending direction of the scan line and/or the data line.

In the display panel of the present disclosure, an area of the main pixel area accounts for 25% to 50% of an entire aperture ratio of the subpixel.

In the display panel of the present disclosure, the area of the main pixel area accounts for 40% to 50% of the entire aperture ratio of the subpixel.

In the display panel of the present disclosure, a pixel structure of the display panel is one of two domains, four domains, or eight domains.

The beneficial effects of the present disclosure are: compared with the conventional display panel having a multi-domain pixel structure, the display panel having the multi-domain pixel structure provided in the present disclosure, by inverting the main pixel areas and sub pixel areas of some pixels in a certain order, is beneficial to increase the degree of disorder of the light emitting positions (the main pixel areas) when the sub pixel areas are faint or even unable to light up during displaying in a medium-low gray scale, thereby improving a uniformity of the light emitting surface, and thereby improving the delicateness of the images.

### DESCRIPTION OF DRAWINGS

In order to more clearly illustrate the technical solutions in the embodiments or the prior art, the drawings to be used in the descriptions of the embodiments or the prior art will be briefly described below. Obviously, the drawings in the following description are merely embodiments of the present disclosure. For those of ordinary skill in the art, other drawings may be obtained from the drawings without any creative work.

FIG. 1 is a schematic structural view of an eight-domains pixel structure of an embodiment according to the present disclosure.

FIG. 2 is a schematic structural view of a display panel of a first embodiment according to the present disclosure.

FIG. 3 is a schematic structural view of another display panel of a first embodiment according to the present disclosure.

FIG. 4 is a schematic structural view of a display panel of a second embodiment according to the present disclosure.

FIG. 5 is a schematic structural view of another display panel of a second embodiment according to the present disclosure.

FIG. 6 is a schematic structural view of another display panel of a second embodiment according to the present disclosure.

### DETAILED DESCRIPTION OF EMBODIMENTS

The following description of the various embodiments refers to the accompanying drawings, and is provided to illustrate the specific embodiments of the invention. Orientational relationships represented by directional terms mentioned in the present disclosure, such as “up”, “down”, “front”, “rear”, “left”, “right”, “inner”, “outer”, or “lateral”, etc. are orientational relationships based on illustration of the drawings. So, the orientational relationships used are for describing and understanding of the present disclosure, rather than limiting the present disclosure. In the figures, structurally similar elements are denoted by the same reference numerals.

The present disclosure is directed at solving the technical problem of a conventional display panel having a multi-domain pixel structure in which the delicateness of images is insufficient in a medium-low gray scale, which affects the display effect.

The present disclosure provides a display panel having a multi-domain pixel structure. The pixel structure of the display panel may be two domains, four domains, or eight domains. This embodiment is described by taking only a 3T_8-domains (eight-domains and 3-transistors) pixel structure as an example.

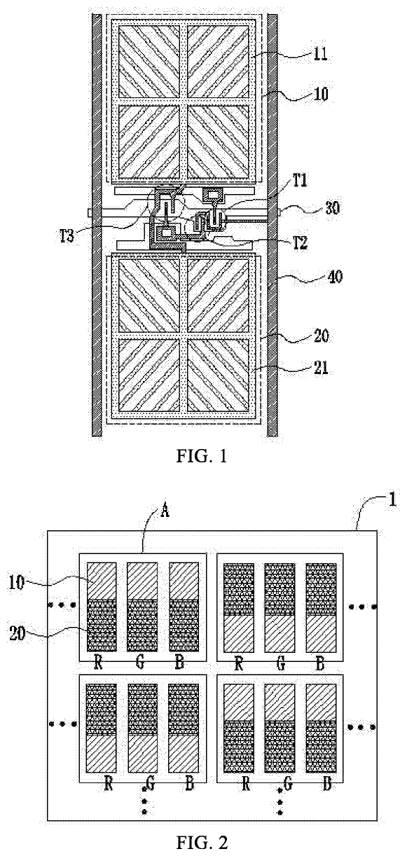

As shown in FIG. 1, it is a schematic structural view of an eight-domains pixel structure. The display panel has a plurality of subpixels disposed in array therein, each of the subpixels includes a main pixel area 10 and a sub pixel area 20. A scan line 30 is provided for each row of the subpixels, the scan line 30 is located between the main pixel area 10 and the sub pixel area 20, and a data line 40 is provided for each column of the subpixels.

The subpixel further includes a main thin film transistor T1 and a main storage capacitor, a sub thin film transistor T2 and a sub storage capacitor, and a shared thin film transistor T3. A gate electrode of the main thin film transistor T1 is coupled to the scan line 30, a drain/source electrode of the main thin film transistor T1 is coupled to the data line 40, and the drain/source electrode is coupled to a main pixel electrode 11 of the corresponding main pixel area 10. A gate electrode of the sub thin film transistor T2 is coupled to the scan line 30, a drain/source electrode of the sub thin film transistor T2 is coupled to the data line 40, and the drain/source electrode is coupled to a sub pixel electrode 21 of the corresponding sub pixel area 20. A gate electrode of the shared thin film transistor T3 is coupled to the scan line 30, and a drain/source electrode of the shared thin film transistor T3 is coupled to the data line 40 and a shared electrode. Therein, the main pixel electrode 11 and the sub pixel electrode 21 both have the shape of double-cross “Union Jack”.

In the display panel provided in the present disclosure, the main pixel area 10 and the sub pixel area 20 of a part of the subpixels are positionally flipped with the main pixel area 10 and the sub pixel area 20 of another part of the subpixels at a preset angle, thereby increasing a degree of disorder of arrangement positions of the main pixel area 10 and the sub pixel area 20. The preset angle is about 10° to 180°. That is, in the display panel provided in the present disclosure, a relative positional relationship of the main pixel area 10 or the sub pixel area 20 of a same row/column subpixel is different, thereby improving insufficient delicateness of images during display in the middle-low gray scale.

As shown in FIG. 2, it is a schematic structural view of a display panel of a first embodiment according to the present disclosure. The display panel 1 includes an array of pixel units A, each of the pixel units A at least includes three subpixels, such as a red subpixel R, a green subpixel G, and a blue subpixel B. Each of the subpixels includes the main pixel area 10 and the sub pixel area 20. The main pixel area 10 and the sub pixel area 20 are set according to a preset area ratio. For example, an area of the main pixel area 10 accounts for 25% to 50% of an entire aperture ratio of the subpixel. A pixel structure of the subpixel is as shown in FIG. 1, which is not repeated here.

In this embodiment, a relative positional relationship between the main pixel area 10 and the sub pixel area 20 of different subpixels in a same pixel unit A remains same. The main pixel area 10 and the sub pixel area 20 of the subpixels in two adjacent pixel units A are 180° inverted in position, thereby increasing a degree of disorder of a light emitting position (the main pixel area 10).

As shown in the figure, among two adjacent pixel units A, in one of the two pixel units A, the main pixel areas 10 of the red subpixel R, the green subpixel G, and the blue subpixel B are correspondingly located upon the sub pixel areas 20 of the red subpixel R, the green subpixel G, and the blue subpixel B; in the other one of the two pixel units A, the main pixel areas 10 of the red subpixel R, the green subpixel G, and the blue subpixel B are correspondingly located below the sub pixel areas 20 of the red subpixel R, the green subpixel G, and the blue subpixel B.

Therein, two adjacent pixel units A are arranged adjacently along an extending direction of the scan line 30 and/or the data line 40.

In an embodiment, the area of the main pixel area 10 accounts for 40% to 50% of the entire aperture ratio of the subpixel. This design can greatly reduce a length and complexity of routing windings of the gate lines and electrode lines caused by the position inversion of the main pixel area 10 or the sub pixel area 20.

In other embodiments, in addition to the above-mentioned three pixels of RGB, the pixel unit A may further include a white subpixel W, that is, the pixel unit includes four sub-pixels of RGBW; or a pixel structure such as RGBG. In addition, it is not limited here.

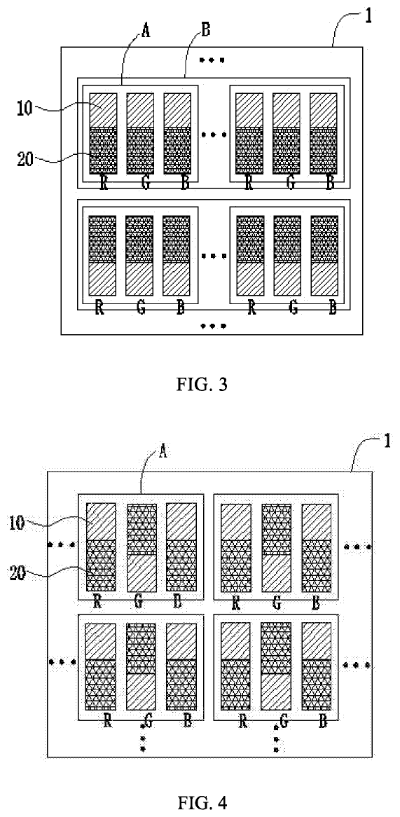

As shown in FIG. 3, it is a schematic structural view of another display panel of the first embodiment according to the present disclosure. The difference between FIG. 3 and FIG. 2 is that: at least two of the pixel units A in the display panel 1 are defined as a pixel group B, and the main pixel area 10 and the sub pixel area 20 of the subpixels in two adjacent pixel groups B are 180° inverted in position.

In other words, the display panel 1 includes a plurality of pixel groups B, each of the pixel groups B includes at least two pixel units A, a relative positional relationship between the main pixel area 10 and the sub pixel area 20 of the all subpixels in each pixel group B remains same. Among two adjacent pixel groups B, in one of the two pixel groups B, the main pixel areas 10 of the all subpixels are correspondingly located upon the sub pixel areas 20 of the all subpixels; in the other one of the two pixel groups B, the main pixel areas 10 of the all subpixels are correspondingly located below the sub pixel areas 20 of the all subpixels.

Therein, two adjacent pixel groups B are arranged adjacently along an extending direction of the scan line 30 and/or the data line 40.

In prior art, the main pixel areas of all subpixels of the display panel are generally located on one side of the sub pixel area, so that the main pixel areas and sub pixel areas of a same row of subpixels are spaced in a straight line, and a fixed and uniform light emission of the main pixels may increase the graininess of some images, which may cause problems such as insufficient delicateness of fine images when displaying in a medium-low gray scale. However, in this embodiment, the positions of the main pixel areas 10 and the sub pixel areas 20 of some pixel units A are reversed in a certain order, which is beneficial to increase the degree of disorder of the light emitting position (the main pixel area 10) when sub pixel areas 20 are faint or even unable to light up during displaying in a medium-low gray scale, it is thereby improving a uniformity of the light emitting surface and the like, and thereby improving the delicateness of the images.

As shown in FIG. 4, it is a schematic structural view of a display panel of a second embodiment according to the present disclosure. The display panel 1 includes an array of pixel units A, each of the pixel units A includes a red subpixel R, a green subpixel G, and a blue subpixel B. Each of the subpixels includes the main pixel area 10 and the sub pixel area 20. The main pixel area 10 and the sub pixel area 20 of two adjacent subpixels in a same pixel unit A are 180° inverted in position,

As shown in the figure, in one of the pixel units A, the main pixel area 10 of the red subpixel R is below the corresponding main pixel area 10 of the red subpixel R, the main pixel area 10 of the green subpixel G is below the corresponding main pixel area 10 of the green subpixel G, and the main pixel area 10 of the blue subpixel B is upon the corresponding main pixel area 10 of the blue subpixel B, or the subpixels are opposite to this design. The pixel units A in the display panel 1 are distributed in such arrayed pixel structures. Therein, a pixel structure of the subpixel is as shown in FIG. 1, which is not repeated here.

Therein, two adjacent subpixels are arranged adjacently along an extending direction of the scan line 30 and/or the data line 40.

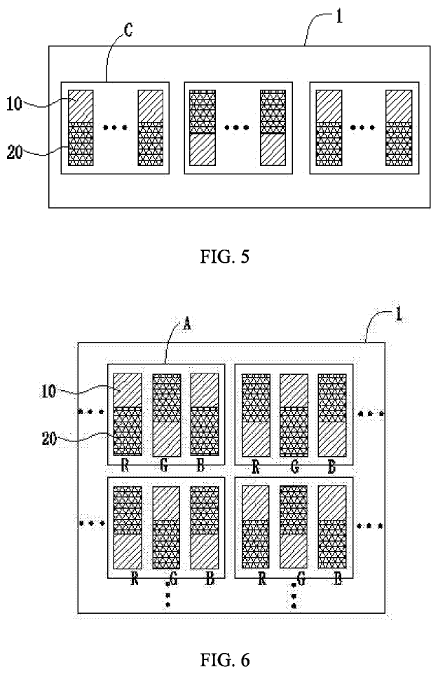

As shown in FIG. 5, it is a schematic structural view of another display panel of the second embodiment according to the present disclosure. The difference between FIG. 5 and FIG. 4 is that: the display panel includes a plurality of sub pixel groups C, each of the sub pixel groups C includes at least two subpixels, a relative positional relationship between the main pixel area 10 and the sub pixel area 20 of the all subpixels in each sub pixel groups C remains same. Among two adjacent sub pixel groups C, in one of the two sub pixel groups C, the main pixel areas 10 of the all subpixels are correspondingly located upon the sub pixel areas 20 of the all subpixels; in the other one of the two sub pixel groups C, the main pixel areas 10 of the all subpixels are correspondingly located below the sub pixel areas 20 of the all subpixels. That is, the main pixel areas 10 and the sub pixel areas 20 in two adjacent sub pixel groups C are 180° inverted in position, thereby increasing the degree of disorder of the main pixel area 10.

Therein, two adjacent sub pixel groups C are arranged adjacently along an extending direction of the scan line 30 and/or the data line 40.

As shown in FIG. 6, it is a schematic structural view of another display panel of the second embodiment according to the present disclosure. The difference between FIG. 6 and FIG. 4 is that: the display panel 1 includes an array of subpixels, and the main pixel areas 10 and the sub pixel areas 20 of two adjacent subpixels are 180° inverted in position.

That is, in addition to positional relationships between the main pixel area 10 and the sub pixel area 20 of two adjacent subpixels in a same pixel unit A being different, positional relationships between the main pixel area 10 and the sub pixel area 20 of a same subpixel in two adjacent pixel units A are also different.

As shown in the figure, among two adjacent pixel units A, in one of the two pixel units A, the main pixel area 10 of the red subpixel R is correspondingly located upon the sub pixel area 20 of the red subpixel R; in the other one of the two pixel units A, the main pixel area 10 of the red subpixel R is correspondingly located below the sub pixel area 20 of the red subpixel R. The designs of the green subpixel G and the blue subpixel B in two adjacent pixel units A are similar to that of the red subpixel R, and details are not described herein again.

Whenever along an extending direction of the scanning line 30 or an extending direction of the data line 40, the main pixel areas 10 and the sub pixels areas 20 of two adjacent subpixels are 180° flipped in position by this design. Therefore, the degree of disorder of the main pixel areas 10 is increased to the greatest extent. When sub pixel areas 20 are faint or even unable to light up during displaying in a medium-low gray scale, the purpose of improving the uniformity of the light emitting surface can be maximized. Thus, the delicateness of the images is improved.

In summary, when sub pixel areas 20 are faint or even unable to light up during displaying in a medium-low gray scale, the display panel having the multi-domain pixel structure provided in the present disclosure, by inverting the main pixel areas and sub pixel areas of some pixels in a certain order, is beneficial for increasing the degree of disorder the light emitting positions (the main pixel areas), thereby improving a uniformity of the light emitting surface, and thereby improving the delicateness of the images.

In the above, the present disclosure has been disclosed as above in the preferred embodiments. However, the preferred embodiments should not be construed as limitations of the present disclosure. Those skilled in the art can make various modifications without departing from the spirit and scope of the present disclosure. Hence, the scope of the present disclosure should be subject to the scope defined in the claims.

What is claimed is:

1. A display panel having a multi-domain pixel structure, comprising an array of pixel units, wherein each of the pixel units comprises at least three subpixels, and each of the at least subpixels comprises a main pixel area and a sub pixel area; and
the main pixel area of the subpixel and the sub pixel area of the subpixel are disposed according to a preset area ratio;
wherein, the main pixel area and the sub pixel area of a part of the subpixels on the display panel are positionally flipped with the main pixel area and the sub pixel area of another part of the subpixels at a preset angle, thereby increasing a degree of disorder of arrangement positions of the main pixel area and the sub pixel area.

2. The display panel as claimed in claim 1, wherein a relative positional relationship between the main pixel area and the sub pixel area of different subpixels in a same pixel unit remains same.

3. The display panel as claimed in claim 2, wherein the main pixel area and the sub pixel area of the subpixels in two adjacent pixel units are 180° inverted in position.

4. The display panel as claimed in claim 2, wherein at least two of the pixel units are defined as a pixel group, and the main pixel area and the sub pixel area of the subpixels in two adjacent pixel groups are 180° inverted in position.

5. The display panel as claimed in claim 1, wherein in a same pixel unit, the main pixel area and the sub pixel area of two adjacent subpixels are 180° inverted in position.

6. The display panel as claimed in claim 5, wherein at least two of the subpixels are defined as a sub-pixel group, and the main pixel area and the sub pixel area of the subpixels in two adjacent sub-pixel groups are 180° inverted in position.

7. The display panel as claimed in claim 6, further comprising a data line and a scan line, wherein two adjacent pixel units, sub-pixels, pixel groups, or sub-pixel groups are arranged adjacently along an extending direction of the scan line and/or the data line.

8. The display panel as claimed in claim 1, wherein an area of the main pixel area accounts for 25% to 50% of an entire aperture ratio of the subpixel.

9. The display panel as claimed in claim 8, wherein the area of the main pixel area accounts for 40% to 50% of the entire aperture ratio of the subpixel.

10. The display panel as claimed in claim 1, wherein a pixel structure of the display panel is one of two domains, four domains, or eight domains.

11. A display panel having a multi-domain pixel structure, comprising an array of pixel units, wherein each of the pixel units comprises at least three subpixels, each of the at least subpixels comprises a main pixel area, a sub pixel area, and three thin film transistors; and
the main pixel area of the subpixel and the sub pixel area of the subpixel are disposed according to a preset area ratio;
wherein, the main pixel area and the sub pixel area of a part of the subpixels on the display panel are positionally flipped with the main pixel area and the sub pixel area of another part of the subpixels at a preset angle, thereby increasing a degree of disorder of arrangement positions of the main pixel area and the sub pixel area.

12. The display panel as claimed in claim 11, wherein a relative positional relationship between the main pixel area and the sub pixel area of different subpixels in a same pixel unit remains same.

13. The display panel as claimed in claim 12, wherein the main pixel area and the sub pixel area of the subpixels in two adjacent pixel units are 180° inverted in position.

14. The display panel as claimed in claim 12, wherein at least two of the pixel units are defined as a pixel group, and the main pixel area and the sub pixel area of the subpixels in two adjacent pixel groups are 180° inverted in position.

15. The display panel as claimed in claim 11, wherein in a same pixel unit, the main pixel area and the sub pixel area of two adjacent subpixels are 180° inverted in position.

16. The display panel as claimed in claim 15, wherein at least two of the subpixels are defined as a sub-pixel group, and the main pixel area and the sub pixel area of the subpixels in two adjacent sub-pixel groups are 180° inverted in position.

17. The display panel as claimed in claim 16, further comprising a data line and a scan line, wherein two adjacent pixel units, sub-pixels, pixel groups, or sub-pixel groups are arranged adjacently along an extending direction of the scan line and/or the data line.

18. The display panel as claimed in claim 11, wherein an area of the main pixel area accounts for 25% to 50% of an entire aperture ratio of the subpixel.

19. The display panel as claimed in claim 18, wherein the area of the main pixel area accounts for 40% to 50% of the entire aperture ratio of the subpixel.

20. The display panel as claimed in claim 11, wherein a pixel structure of the display panel is one of two domains, four domains, or eight domains.
